(19) United States
(12) Patent Application Publication
(10) Pub. No.: US 2006/0252436 A1
(43) Pub. Date: Nov. 9, 2006

(54) Interference control method, network element, device, computer program product and computer program distribution medium

(75) Inventors: Olav Tirkkonen, Helsinki (FI); Mikko Kokkonen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/153,399

(22) Filed: Jun. 16, 2005

(30) Foreign Application Priority Data
May 6, 2005 (FI) 20050484

(51) Int. Cl. H04B 15/00; H04B 1/00

(52) U.S. Cl. 455/501; 455/63.1

(57) ABSTRACT

The invention is related to a computer program product encoding a computer program of instructions for executing a computer process for interference control, the process comprising: setting a first power constraint for multi-antenna transmissions; setting a second power constraint for single-stream transmissions, wherein the first power constraint and the second power constraint control the use of predetermined resources in a way that the resources are reserved for the single-stream transmissions or the resources are allowed for the multi-antenna transmissions and for the single-stream transmissions, the power level of the multi-antenna transmissions being lower than the power level of the single-antenna transmissions.

### FIELD

The invention relates to an interference control method in a communication system, a network element, a device, a computer program product and a computer program distribution medium.

### BACKGROUND

In re-use 1 systems, users near the edges of a radio cell typically experience low, even very low, signal-to-noise-and-interference ratios. In prior art, soft handovers have typically been used for improving the signal quality of there users. A soft handover to an interfering channel makes the interfering signal a part of a desired signal. However, especially in downlink communication, soft handovers reserve capacity in multiple cells, thus diminishing the system throughput.

Modern downlink packet data systems, such as High Speed Downlink Packet Access (HSDPA), do not apply a soft handover. Therefore, other means to reduce the effects of interference are required. Examples of such means are interference rejection or nulling carried out in a receiver. A problem is that the efficiency of interference rejection algorithms depends on the type of interference. For instance, if an interfering signal is a multi-stream (or a multi-beam) signal, there may not be enough information available on the interfering signal to obtain an effective interference rejection.

### BRIEF DESCRIPTION OF THE INVENTION

According to an aspect of the invention, there is provided an interference control method in a communication system, the method comprising: setting a first power constraint for multi-antenna transmissions; setting a second power constraint for single-stream transmissions, wherein the first power constraint and the second power constraint control the use of predetermined resources in a way that at least a part of the resources are reserved for the single-stream transmissions or at least a part of the resources are allowed for the multi-antenna transmissions and for the single-stream transmissions, the power level for the multi-antenna transmissions being set lower than the power level for the single-antenna transmissions by means of the power constraints.

According to another aspect of the invention, there is provided an interference control method in a communication system, the method comprising: setting different power constraints for single-stream transmissions having at least one different character, wherein the power constraints control the use of predetermined resources by allocating the resources for the single-stream transmissions in a way that interference circumstances in adjacent cells are improved.

According to another aspect of the invention, there is provided an interference control method in a communication system, the method comprising: determining at least one character on the basis of which transmission groups are formed; setting group-specific power constraints for the transmissions, wherein the group-specific power constraints control the use of predetermined resources by allocating the resources for the transmission groups in a way that interference circumstances in adjacent cells are improved.

According to another aspect of the invention, there is provided a network element, comprising: means for controlling interference by using a predetermined first power constraint for multi-antenna transmissions and a predetermined second power constraint for single-stream transmissions, the control being carried out in a way that predetermined resources are reserved for the single-stream transmissions or predetermined resources are allowed for the multi-antenna transmissions and for the single-stream transmissions, the power level for the multi-antenna transmissions being set lower than the power level for the single-antenna transmissions by means of the power constraints.

According to another aspect of the invention, there is provided a network element, comprising: means for controlling interference by using predetermined characterizing power constraints for single-stream transmissions and by carrying out resource allocation in a way that interference circumstances in adjacent cells are improved.

According to another aspect of the invention, there is provided a network element, comprising: means for controlling interference by using predetermined transmission group-specific power constraints in allocation of predetermined resources for the transmission groups.

According to another aspect of the invention, there is provided a device, comprising: means for controlling interference by using a predetermined first power constraint for multi-antenna transmissions and a predetermined second power constraint for single-stream transmissions, the control being carried out in a way that predetermined resources are reserved for the single-stream transmissions or predetermined resources are allowed for the multi-antenna transmissions and for the single-stream transmissions, the power level for the multi-antenna transmissions being set lower than the power level for the single-antenna transmissions by means of the power constraints.

According to another aspect of the invention, there is provided a device, comprising: means for controlling interference by using predetermined characterizing power constraints for single-stream transmissions and by carrying out resource allocation in a way that interference circumstances in adjacent cells are improved.

According to another aspect of the invention, there is provided a device, comprising: means for controlling interference by using predetermined transmission group-specific power constraints in allocation of predetermined resources for the transmission groups.

According to another aspect of the invention, there is provided a computer program product encoding a computer program of instructions for executing a computer process for interference control, the process comprising:setting a first power constraint for multi-antenna transmissions; setting a second power constraint for single-stream transmissions, wherein the first power constraint and the second power constraint control the use of predetermined resources in a way that at least a part of the resources are reserved for the single-stream transmissions or at least a part of the resources are allowed for the multi-antenna transmissions and for the single-stream transmissions, the power level for the multi-antenna transmissions being set lower than the power level for the single-antenna transmissions by means of the power constraints.

According to another aspect of the invention, there is provided a computer program distribution medium readable by a computer and encoding a computer program of instructions for executing a computer process for interference control, the process comprising: setting a first power constraint for multi-antenna transmissions; setting a second power constraint for single-stream transmissions, wherein the first power constraint and the second power constraint control the use of predetermined resources in a way that at least a part of the resources are reserved for the single-stream transmissions or at least a part of the resources are allowed for the multi-antenna transmissions and for the single-stream transmissions, the power level for the multi-antenna transmissions being set lower than the power level for the single-antenna transmissions by means of the power constraints.

According to another aspect of the invention, there is provided a network element, configured to: control interference by using a predetermined first power constraint for multi-antenna transmissions and a predetermined second power constraint for single-stream transmissions, the control being carried out in a way that predetermined resources are reserved for the single-stream transmissions or predetermined resources are allowed for the multi-antenna transmissions and for the single-stream transmissions, the power level for the multi-antenna transmissions being set lower than the power level for the single-antenna transmissions by means of the power constraints.

According to another aspect of the invention, there is provided a network element, configured to: control interference by using predetermined characterizing power constraints for single-stream transmissions and by carrying out resource allocation in a way that interference circumstances in adjacent cells are improved.

According to another aspect of the invention, there is provided a network element, configured to: control interference by using predetermined transmission group-specific power constraints in allocation of predetermined resources for the transmission groups.

According to another aspect of the invention, there is provided a device, configured to: control interference by using a predetermined first power constraint for multi-antenna transmissions and a predetermined second power constraint for single-stream transmissions, the control being carried out in a way that predetermined resources are reserved for the single-stream transmissions or predetermined resources are allowed for the multi-antenna transmissions and for the single-stream transmissions, the power level for the multi-antenna transmissions being set lower than the power level for the single-antenna transmissions by means of the power constraints

According to another aspect of the invention, there is provided a device, configured to: control interference by using predetermined characterizing power constraints for single-stream transmissions and by carrying out resource allocation in a way that interference circumstances in adjacent cells are improved.

According to another aspect of the invention, there is provided a device, configured to: control interference by using predetermined transmission group-specific power constraints in allocation of predetermined resources for the transmission groups.

The invention provides several advantages.

An embodiment of the invention provides a possibility of controlling interference, thus enabling an effective and practical interference rejection.

### LIST OF DRAWINGS

In the following, the invention will be described in greater detail with reference to the embodiments and the accompanying drawings, in which

FIG. 1 shows an example of a communication system;

FIG. 2 is a flow chart;

FIG. 3 is another flow chart;

FIGS. 4A-B show examples of interference control;

FIGS. 5A-B show examples of interference control;

FIGS. 6A-B show examples of interference control;

FIGS. 7A-B show examples of interference control;

FIGS. 8A-B show examples of interference control; and

FIG. 9 illustrates an example of a network element.

### DESCRIPTION OF EMBODIMENTS

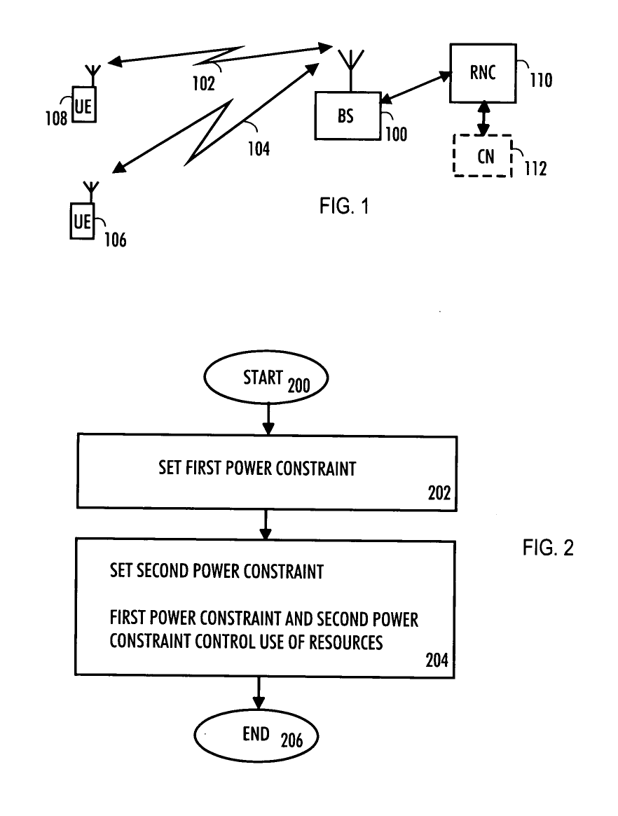

With reference to FIG. 1, we examine an example of a communication system to which embodiments of the invention can be applied. The present invention can be applied to various communication systems. One example of such a communication system is a Universal Mobile Telecommunications System (UMTS) radio access network. It is a radio access network which includes wideband code division multiple access (WCDMA) technology and can also offer real-time circuit and packet switched services. Another example is an Enhanced Data Rates for Global Evolution (EDGE). The embodiments are not, however, restricted to the systems given as examples but a person skilled in the art may apply the solution to other communication systems provided with the necessary properties.

It is clear to a person skilled in the art that the method according to the invention can be applied to systems utilizing different air interface standards. Orthogonal frequency division multiplexing (OFDM) is widely used in wireless local and metropolitan area networks. In an evolved UMTS terrestrial radio access network (UTRAN), the downlink is proposed to be based on OFDM, and for the uplink, various frequency division multiple access (FDMA) methods have been proposed. Any modulation and coding method may be used, such as quadrature phase shift keying (QPSK), as well as any multi-antenna transmission method.

FIG. 1 is a simplified illustration of a data transmission system to which the solution according to the invention is applicable. This is a part of a cellular radio system, which comprises a base station (or node B) 100, which has bi-directional radio links 102 and 104 to subscriber terminals 106 and 108. The subscriber terminals may be fixed, vehicle-mounted or portable. The base station includes transceivers, for instance. From the transceivers of the base station, there is a connection to an antenna unit that establishes the bi-directional radio links to the subscriber terminals. The base station is further connected to a controller 110, a radio network controller (RNC) or a base station controller (BSC), which transmits the connections of the terminals to the other parts of the network. The base station controller of the radio network controller controls in a centralized manner several base stations connected to it. The base station controller or the radio network controller is further connected to a core network 112 (CN). Depending on the system, the counterpart on the CN side can be a mobile services switching centre (MSC), a media gateway (MGW) or a serving GPRS (general packet radio service) support node (SGSN), etc.

It should be noticed that in future radio networks, the functionality of an RNC or a BSC may be distributed among (possibly a subset of) base stations.

The radio system can also communicate with other networks, such as a public switched telephone network or the Internet.

Embodiments of the invention offer a resource, typically time or spectrum, allocation method which reserves a part of available resources for single-stream or single-beam transmissions. To give one example, in Orthogonal Frequency Division Multiplexing (OFDM) systems, one resource is thus one sub-carrier during one symbol period.

In the embodiments, instead of or in addition to the controlling of the level of interference, the quality or nature of interference is controlled. In other words, the embodiments of the invention may be used instead of prior art methods controlling the level of interference, such as conventional power allocation methods, or in addition to them.

Since the use of multi-antenna systems is of a great interest, several techniques have been introduced to combine diversity antennas or different antenna branches of antenna arrays in reception to create nulls towards interfering signals while maintaining a large antenna gain towards the desired signal, thus reducing interference. One example of such a combining technique is interference rejection combining (IRC).

One source of interference is other users. Users operating on identical carrier frequencies in neighbouring cells may create co-channel interference (CCI), while users operating on adjacent carrier frequencies may create adjacent-channel interference (ACI).

The classification of multi-antenna transmission formats used in this application is:

single-stream transmissions which are further classified as:
1. single-beam transmissions where transmission covariance from multiple antennas in a resource has rank 1, such as single-antenna transmission or beamforming transmissions.
2. space-time/frequency coded single-stream transmissions where transmission covariance from multiple antennas in two resources has rank 2. Space-time/frequency coded transmissions may also be considered as constrained multi-beam transmissions.
multi-stream transmissions where the rank of the transmission co-variance from multiple antennas in any N resources is >N, such as multi-stream Multiple Input—Multiple Output (MIMO) transmissions and high rate matrix modulations with a symbol rate greater than 1. Multi-stream transmissions can always be considered as multi-beam transmissions.

In the following, single-stream transmissions also mean single-beam transmissions and multi-antenna transmissions include multi-stream transmissions and multi-beam transmissions unless said otherwise. Also adjacent cells include both adjacent cells and adjacent sectors.

Next, an embodiment of the interference control method is explained in further detail by means of FIG. 2. The embodiment starts in block 200.

In block 202, a first power constraint for multi-antenna transmissions is set. Multi-antenna transmissions include multi-stream transmissions and multi-beam transmissions.

In block 204, a second power constraint for single-stream transmissions is set.

The first power constraint and the second power constraint control the use of predetermined resources in a way that at least a part of the resources are reserved for the single-stream transmissions or at least a part of the resources are allowed for the multi-antenna transmissions and for the single-stream transmissions, but the power level for the multi-antenna transmissions is set to be lower than the power level for the single-antenna transmissions.

The resources may be frequency channels, time slots, etc.

The first power constraint for at least some resources in some sectors and the second power constraint may be set to be cell-specific or sector-specific. They may also be set for several cells or sectors.

The first power constraint is selected to be smaller than the second power constraint, at least for selected resources in selected sectors (or cells). The first power constraint may even be zero, which means that certain resources are reserved only for single-stream transmissions. Power constraints are typically searched for by using the network level or some other kinds of simulations. Power constraints may be determined as a part of network planning.

Transmissions in one cell (or sector) typically cause interference in adjacent cells.

The use of different power constraints enables effective interference rejection in adjacent cells. If the second power constraint allows more power to be used for transmissions than the first one, at a cellular boundary where strong interference is often experienced in adjacent cells, strong interference is caused by a single-stream transmission and thus it is suitable for interference rejection or nulling.

Several prior art interference rejection methods are provided. Typically, interference in a received signal is reduced by blind methods where the signal covariance is estimated and the received signal is whitened. More advanced methods, such as carrying out synchronization to the source of interference or performing interference cancellation based on estimating symbols transmitted by the source of interference, may be used as well.

When applying a strict enough power constraint to possible multi-antenna transmissions, these transmissions can cause only weak interference in adjacent cells. This is beneficial, since the interference caused by a multi-antenna transmission may not be suitable for interference rejection methods designed for single-stream transmissions or the methods are not effective enough. Thus, for a user close to a cell boundary, it is preferable that the level of interference caused by multi-antenna transmissions is low at least in some resources. This offers an option that resources less affected by the interference caused by multi-antenna transmissions may be allocated to at least some users.

It should also be noticed that frequency resources used for the embodiment described above may be used to provide frequency diversity.

The embodiment ends in block 206.

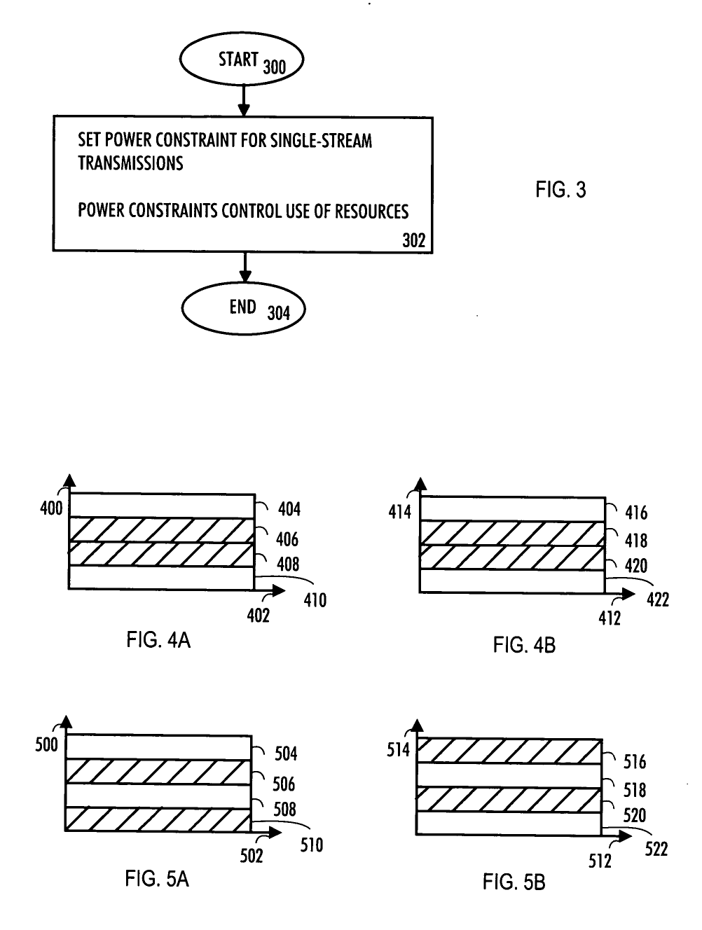

Next, another embodiment of the interference control method is explained in further detail by means of FIG. 3. The embodiment starts in block 300.

In block 302, different power constraints are set for single-stream transmissions having at least one different character. For example, space-time coded single-stream transmissions have a different power constraint than other kind of single-stream transmissions.

The power constraints control the use of predetermined resources by allocating the resources for the single-stream transmissions in a way that interference circumstances in adjacent cells are improved. The resources may be frequency channels, time slots, etc.

A generic IRC algorithm may not be sufficient for rejecting interference caused by a space-time or space-frequency coded single-stream transmission (e.g. Space Time Transmit Diversity, STTD). However, if an IRC algorithm is provided with information on the cyclostationary structure of interference, a space-time or space-frequency IRC algorithm may be feasible.

Transmissions in one cell (or sector) typically cause interference in adjacent cells (or sectors).

The use of different power constraints enables interference rejection in adjacent cells in a similar way to the embodiment described above. The interference control is based on the usage of different power levels for different kinds of transmissions.

The embodiment ends in block 304.

In other words, in embodiments of the interference control method, power constraints are group-specific and transmissions may also from groups on the basis of characters other than the ones used as examples. Generally speaking, at least one character is determined on the basis of which transmissions form groups and group-specific power constraints for the transmissions are set. The group-specific power constraints control the use of predetermined resources by allocating the resources for the transmission groups in a way that interference circumstances in adjacent cells are improved.

One example of implementation of the embodiments uses OFDM modulation in a way that a subset of sub-carriers is allocated for single-stream transmissions, or single-stream transmissions on a set of sub-carriers are allowed to be transmitted with a higher power than multi-antenna transmissions.

Generally, interference control may be implemented by allocating certain resources in all sectors (or cells) in a selected area for single-stream transmissions. Another example is to allocate certain resources in all sectors (or cells) in a selected area for both single-stream transmissions and multi-antenna transmissions.

The embodiments may be implemented in such a way that in a cell, especially in a cell boundary, the type of a transmission is limited to be, for instance, a single-stream transmission. Thus, in adjacent cells, it is possible to carry out interference rejection at least in some resources. In adjacent cells, there is also an option to use less interfered resources. In resource allocation, signal-to-interference ratio (SIR) measurements may be used.

Next, some examples of interference control are depicted by means of FIGS. 4A to 8B.

When controlling interference, certain resources (e.g. frequency and/or time resources) in a given sector (or cell) are reserved for single-stream transmissions, or on certain resources multi-stream transmissions are allowed with a lower power than single-stream transmissions.

Interference control by using power constraints can be realized in a static or dynamic way. In a static allocation, the selection of resources on which multi-antenna transmissions are constrained to have a lower power (or multi-antenna transmissions are not allowed at all), remains fixed for long periods of time, and may even be made when the communication system is set up. Static allocation may further be classified into static allocation requiring anticipatory planning of the network, and allocation requiring no planning at all.

In a dynamic allocation, the selection of resources and/or the allowed power for multi-antenna transmissions on a resource may change dynamically in time.

An example of the latter type of static allocation is depicted in FIGS. 4A-B.

In FIG. 4A, axis 400 illustrates resources of a first sector and axis 402 illustrates allowed power in the same sector. Resources 404 and 410 are reserved only for single-stream transmissions. Resources 406 and 408 are allowed for both multi-antenna transmissions and single-stream transmissions.

In FIG. 4B, axis 414 illustrates resources of a second sector (an adjacent sector) and axis 412 illustrates allowed power in the same sector. Resources 416 and 422 are reserved only for single-stream transmissions. Resources 418 and 420 are allowed for both multi-antenna transmissions and single-stream transmissions. As can be seen, corresponding resources are reserved for single-stream transmissions in both sectors.

FIGS. 5A-B show another example of a static allocation.

In FIG. 5A, axis 500 illustrates resources of a first sector and axis 502 illustrates allowed power in the same sector. Resources 504 and 508 are reserved only for single stream transmissions. Resources 506 and 510 are allowed for both multi-antenna transmissions and single-stream transmissions.

In FIG. 5B, axis 514 illustrates resources of a second sector (an adjacent sector) and axis 512 illustrates allowed power in the same sector. Resources 518 and 522 are reserved only for single-stream transmissions. Resources 516 and 520 are allowed for both multi-antenna transmissions and single-stream transmissions.

As can be seen, in different sectors, the usage of different resources exclusively for single-stream transmissions is allowed. To fully utilize the potential of such a division of resources, anticipatory planning is required.

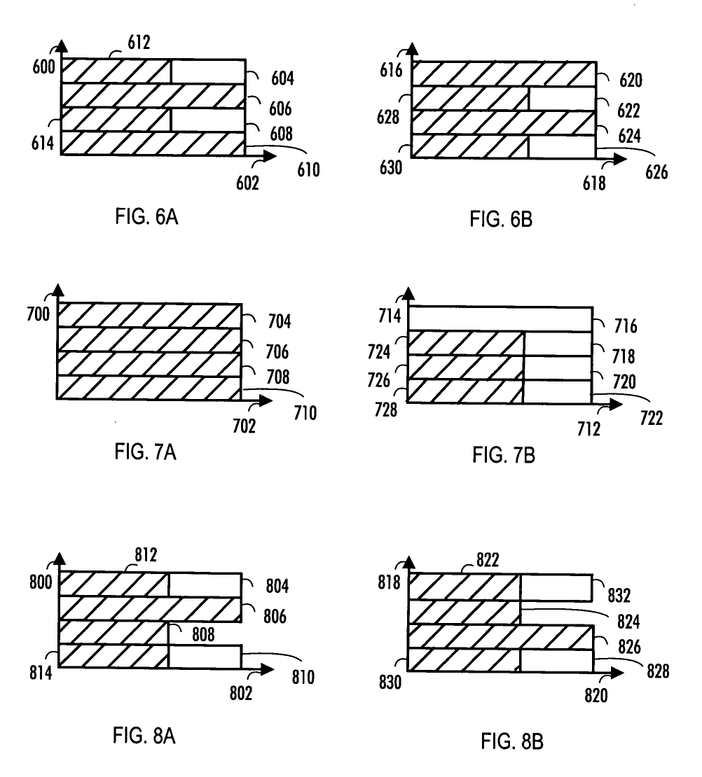

An example of a static allocation with a non-zero power level for multi-antenna transmissions and a higher power level for single-stream transmissions is depicted in FIGS. 6A-B.

In FIG. 6A, axis 600 illustrates resources of a first sector and axis 602 illustrates allowed power in the same sector. Resources 604 and 608 are allowed for both single-stream transmissions and multi-antenna transmissions, but for multi-antenna transmissions, the allowed maximum power level may be lower. On resources 604 and 608, the region of allowed power for multi-antenna transmissions is depicted by regions 612 and 614, respectively. Resources 606 and 610 are allowed for both single-stream and multi-antenna transmissions with the same allowed maximum power level.

In FIG. 6B, axis 616 illustrates resources of a first sector and axis 618 illustrates allowed power in the same sector. Resources 622 and 626 are allowed for both single-stream transmissions and multi-antenna transmissions, but for multi-antenna transmissions, the allowed maximum power level may be lower. On resources 622 and 624, the region of allowed power for multi-antenna transmissions is depicted by regions 628 and 630, respectively. Resources 620 and 624 are allowed for both single-stream and multi-antenna transmissions with the same allowed maximum power level.

As can be seen, in different sectors, it is allowable to use higher power for single-stream transmission on different resources. To fully utilize the potential of such a division of resources, anticipatory planning is required.

In network planning, more resources may be allocated to hot spots. By means of FIG. 7A, it is shown that in a hot spot area, it is possible to apply unconstrained resource allocation.

In FIG. 7A, axis 700 illustrates hot spot resources and axis 702 illustrates allowed power in a hot spot. All resources 704, 706, 708 and 710 are allowed for both single-stream transmissions and multi-antenna transmissions with the same maximum power for single-stream and multi-antenna transmissions.

By means of FIG. 7B, it is shown that a neighboring sector has a constraint for both interference level and quality.

In FIG. 7B, axis 714 illustrates resources of a neighboring sector and axis 712 illustrates allowed power in a neighboring sector. Resource 716, is reserved only for single-stream transmissions. The rest of the resources, i.e. resources 718, 720 and 722, are shared by single-stream transmissions and multi-antenna transmissions. For multi-antenna transmissions, the allowed maximum power level may be lower than for single-stream transmissions. On resources 718, 720 and 722, the region of allowed power for multi-antenna transmissions is depicted by reference numbers 724, 726 and 728, respectively.

FIGS. 8A-B illustrate how prior art power level control can be applied together with the interference control explained above.

In FIG. 8A, axis 800 illustrates resources of a first sector and axis 802 illustrates allowed power in the same sector. Resource 806 is allowed for single-stream and multi-antenna transmissions with the same maximum power level as for single stream transmissions. Resources 804 and 810 are shared by single stream transmissions and multi-antenna transmissions. For multi-antenna transmissions, the allowed maximum power level may be lower than for single-stream transmissions. On resources 804 and 810, the region of allowed power for multi-antenna transmissions is depicted by 812 and 814, respectively. Resource 808 is allowed for both single stream and multi-antenna transmissions. Resource 808 has a lower upper limit for power level.

In FIG. 8B, axis 818 illustrates resources of a second sector (an adjacent sector) and axis 820 illustrates allowed power in the same sector. Resource 826 is allowed for both single-stream transmissions and multi-antenna transmissions typically with the same allowed power level. Also resource 824 is allowed for both single-stream and multi-antenna transmissions, but resource 824 has a lower upper limit for power level. Resources 828 and 832 are allowed for single-stream or multi-antenna transmissions. For multi-antenna transmissions, the allowed maximum power level may be lower than for single-stream transmissions. On resources 828, and 832, the region of allowed power for multi-antenna transmissions is depicted by reference numbers 830 and 822, respectively.

It is obvious to a person skilled in the art that also other possibilities than those depicted in FIGS. 4A to 8B exit for resource allocation taking into account interference circumstances in adjacent cells exist.

A dynamic interference control may be carried out in a local (non-coordinated) or non-local (coordinated) way. In a non-coordinated embodiment, the coverage area of one base station includes a plurality of sectors (or cells). Different power constraints for different kinds of transmission are applied to sets of resources in the time or frequency domain without a need for coordination with other base stations. This is a suitable method to coordinate sector-specific schedulers to control the quality of inter-sector interference.

In a coordinated dynamic interference control, there are base station or sector (or cell) specific different power constraints for different kinds of transmission for different resources which are determined by a network element, such as a Radio Resource Optimizer (RRO) or a distributed network protocol, such as Radio Resource Management (RRM). An RRO may be a separate unit or a part of another network element, such as a radio network controller. Also, the functionality of a RRO may be distributed among a number of network elements, such as base stations.

In an asynchronous network, power constraints may be determined for sets of resources in the frequency domain.

There is also an option to set upper limits for power constraints for different transmissions determined by a network element or a distributed network protocol. A base station may further reduce selected power constraints on a sector-to-sector (cell-to-cell) basis.

In an asynchronous network, network-determined power constraints may be determined for sets of resources in the frequency domain, whereas the base station may further reduce the power constraints used in different sectors (or cells) for sets of resources in the time or frequency domain.

The dynamic interference control may be used as well as the static interference control to produce scenarios shown in FIGS. 4A-8B.

In multi-antenna sectors (or cells), pilot signals are transmitted by using all antennas. If pilot signals and data are time-multiplexed, this may introduce high-rank interference which affects IRC performance.

In embodiments where there are two non-zero power levels, that is when resources allowed for both multi-antenna transmissions with non-zero power and single-stream transmissions with a higher power than that of multi-antenna transmissions (see FIGS. 6A-B) are provided, pilot design becomes an important issue. If common pilots are used, a receiver needs information on the power level of a transmitted data signal. The information may be obtained by signalling, or by the knowledge of power levels used in the sector (or cell).

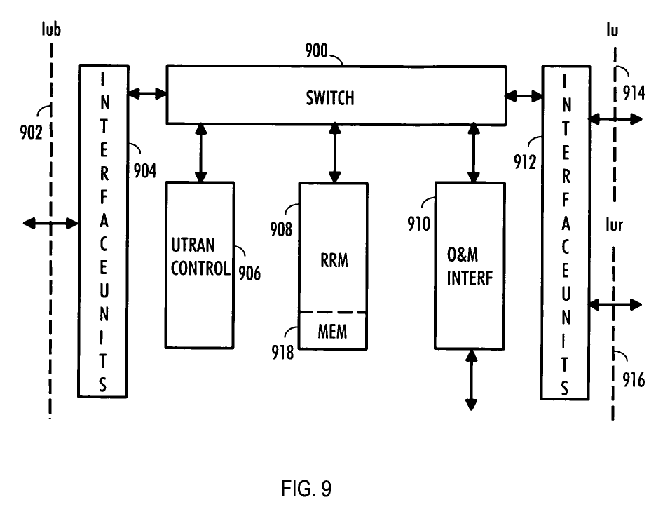

Referring to FIG. 9, a simplified block diagram illustrates an example of the logical structure of a radio network controller. A radio network controller is herein taken as an example of a network element. A radio network controller (RNC) is the switching and controlling element of UTRAN. The switching 900 takes care of the connection between a core network and user devices, such as a mobile phones. The radio network controller is located between lub 902 and lu 914 interfaces. The network controller in connected to these interfaces via interface units 904, 912. There is also an interface for inter-RNC transmission called lur 916.

The functionality of the radio network controller can be classified into two classes: UTRAN radio resource management 908 and control functions 906. An operation and management interface function 910 serves as a medium for information transfer to and from network management functions. The radio resource management is a group of algorithms used to share and manage the radio path connection so that the quality and capacity of the connection are adequate. The most important radio resource management algorithms are handover control, power control, admission control, packet scheduling, and code management. The UTRAN control functions take care of functions related to the set-up, maintenance and release of a radio connection between the base stations and the user device.

Radio resource management 908 may also utilise memory resources 918; for instance, group-specific power constraints may be stored in a memory unit.

The precise implementation of the radio network controller is vendor-dependent.

The disclosed functionalities of the preferred embodiments of the invention can be advantageously implemented by means of software in a network element, such as a radio network controller, a Radio Resource Optimizer (RRO), a base station or a corresponding device. A computer program for performing the embodiments described above may be a part of software carrying out other radio resource management functions, such as power control.

The embodiments may be implemented as a computer program comprising instructions for executing a computer process for setting a first power constraint for multi-antenna transmissions, setting a second power constraint for single-stream transmissions, wherein the first power constraint and the second power constraint control the use of predetermined resources in a way that at least a part of the resources are reserved for the single-stream transmissions or at least a part of the resources are allowed for the multi-antenna transmissions and for the single-stream transmissions, the power level for the multi-antenna transmissions being lower than the power level for the single-antenna transmissions.

The setting of power constraints while executing a computer program typically means that predetermined power constraints are put into use.

It should be noticed that the invention may be used for controlling interference both in an uplink and in a downlink transmission in a cellular communication system or in a system comparable to it.

The computer program may be stored on a computer program distribution medium readable by a computer or a processor. The computer program medium may be, for example but not limited to, an electric, magnetic, optical, infrared or semiconductor system, device or transmission medium. The medium may be a computer readable medium, a program storage medium, a record medium, a computer readable memory, a random access memory, an erasable programmable read-only memory, a computer readable software distribution package, a computer readable signal, a computer readable telecommunications signal, and a computer readable compressed software package.

Even though the invention has been described above with reference to examples according to the accompanying drawings, it is clear that the invention is not restricted thereto but it can be modified in several ways within the scope of the appended claims.

1. An interference control method in a communication system, the method comprising:
setting a first power constraint for multi-antenna transmissions; and
setting a second power constraint for single-stream transmissions,
wherein the first power constraint and the second power constraint control the use of predetermined resources in a way that at least a part of the resources are reserved for the single-stream transmissions or at least a part of the resources are allowed for the multi-antenna transmissions and for the single-stream transmissions, a power level for the multi-antenna transmissions being set lower than a power level for the single-antenna transmissions by means of the first power constraint and the second power constraint.

2. The method of claim 1, wherein the predetermined resource is spectrum and frequencies of the spectrum are used to provide frequency diversity.

3. The method of claim 1, wherein orthogonal frequency division multiplexing modulation is used in a way that a subset of sub-carriers is reserved for single-stream transmissions, or single-stream transmissions on a set of sub-carriers are allowed to be transmitted with a higher power than multi-antenna transmissions.

4. The method of claim 1, further comprising allocating resources less affected by interference caused by multi-antenna transmissions to selected users.

5. The method of claim 1, further comprising realizing an interference control by using static allocation, wherein the resource selection for multi-stream transmissions is made while the communication system is set up.

6. The method of claim 1, further comprising realizing an interference control for both uplink and downlink transmissions.

7. An interference control method in a communication system, the method comprising:
setting different power constraints for single-stream transmissions having at least one different character,
wherein the power constraints control the use of predetermined resources by allocating the resources for the single-stream transmissions in a way that interference circumstances in adjacent cells are improved.

8. The method of claim 7, wherein a different power constraint is set for space-time coded single-stream transmissions than other kind of single-stream transmissions.

9. An interference control method in a communication system, the method comprising:
determining at least one character on the basis of which transmission groups are formed; and
setting group-specific power constraints for the transmission groups,
wherein the group-specific power constraints control the use of predetermined resources by allocating the resources for the transmission groups in a way that interference circumstances in adjacent cells are improved.

10. A network element, comprising:
means for controlling interference by using a predetermined first power constraint for multi-antenna transmissions and a predetermined second power constraint for single-stream transmissions, a control being carried out in a way that predetermined resources are reserved for the single-stream transmissions or predetermined resources are allowed for the multi-antenna transmissions and for the single-stream transmissions, a power level for the multi-antenna transmissions being set lower than a power level for the single-antenna transmissions by means of the power constraints.

11. The network element of claim 10, wherein the predetermined resource is spectrum and frequencies of the spectrum are used to provide frequency diversity.

12. The network element of claim 10, further comprising means for using orthogonal frequency division multiplexing in a way that a subset of sub-carriers is reserved for single-stream transmissions, or single-stream transmissions on a set of sub-carriers are allowed to be transmitted with a higher power than multi-antenna transmissions.

13. The network element of claim 10, further comprising means for allocating resources less affected by interference caused by multi-antenna transmissions to selected users.

14. The network element of claim 10, further comprising means for realizing an interference control by using static allocation, wherein the resource selection for multi-stream transmissions is made while the communication system is set up.

15. The network element of claim 10, further comprising means for realizing an interference control for both uplink and downlink transmissions.

16. A network element, comprising:
means for controlling interference by using predetermined characterizing power constraints for single-stream transmissions and by carrying out resource allocation in a way that interference circumstances in adjacent cells are improved.

17. A network element, comprising:
means for controlling interference by using predetermined transmission group-specific power constraints in allocation of predetermined resources for transmission groups.

18. A device, comprising:
means for controlling interference by using a predetermined first power constraint for multi-antenna transmissions and a predetermined second power constraint for single-stream transmissions, a control being carried out in a way that predetermined resources are reserved for the single-stream transmissions or predetermined resources are allowed for the multi-antenna transmissions and for the single-stream transmissions, a power level for the multi-antenna transmissions being lower than a power level for the single-antenna transmissions.

19. A device, comprising:
means for controlling interference by using predetermined characterizing power constraints for single-stream transmissions and by carrying out resource allocation in a way that interference circumstances in adjacent cells are improved.

20. A device, comprising:
means for controlling interference by using predetermined transmission group-specific power constraints in allocation of predetermined resources for transmission groups.

21. A computer program product embodied within a computer readable medium, the computer program product encoding a computer program of instructions for executing a computer process for interference control, the process comprising:
setting a first power constraint for multi-antenna transmissions; and
setting a second power constraint for single-stream transmissions,
wherein the first power constraint and the second power constraint control the use of predetermined resources in a way that at least a part of the resources are reserved for the single-stream transmissions or at least a part of the resources are allowed for the multi-antenna transmissions and for the single-stream transmissions, a power level for the multi-antenna transmissions being set lower than a power level for the single-antenna transmissions by means of the power constraints.

22. A computer program distribution medium readable by a computer and encoding a computer program of instructions for executing a computer process for interference control, the process comprising:
setting a first power constraint for multi-antenna transmissions; and
setting a second power constraint for single-stream transmissions,
wherein the first power constraint and the second power constraint control the use of predetermined resources in a way that at least a part of the resources are reserved for the single-stream transmissions or at least a part of the resources are allowed for the multi-antenna transmissions and for the single-stream transmissions, a power level for the multi-antenna transmissions being set lower than a power level for the single-antenna transmissions by means of the power constraints.

23. The computer program distribution medium of claim 22, the distribution medium including at least one of the following media: a computer readable medium, a program storage medium, a record medium, a computer readable memory, a computer readable software distribution package, a computer readable signal, a computer readable telecommunications signal, and a computer readable compressed software package.

24. A network element, configured to:
control interference by using a predetermined first power constraint for multi-antenna transmissions and a predetermined second power constraint for single-stream transmissions, a control being carried out in a way that predetermined resources are reserved for the single-stream transmissions or predetermined resources are allowed for the multi-antenna transmissions and for the single-stream transmissions, a power level for the multi-antenna transmissions being set lower than a power level for the single-antenna transmissions by means of the power constraints.

25. A network element, configured to:
control interference by using predetermined characterizing power constraints for single-stream transmissions and by carrying out resource allocation in a way that interference circumstances in adjacent cells are improved.

26. A network element, configured to:
control interference by using predetermined transmission group-specific power constraints in allocation of predetermined resources for transmission groups.

27. A device, configured to:
control interference by using a predetermined first power constraint for multi-antenna transmissions and a predetermined second power constraint for single-stream transmissions, the control being carried out in a way that predetermined resources are reserved for the single-stream transmissions or predetermined resources are allowed for the multi-antenna transmissions and for the single-stream transmissions, the power level for the multi-antenna transmissions being set lower than the power level for the single-antenna transmissions by means of the power constraints

28. A device, configured to:
control interference by using predetermined characterizing power constraints for single-stream transmissions and by carrying out resource allocation in a way that interference circumstances in adjacent cells are improved.

29. A device, configured to:
control interference by using predetermined transmission group-specific power constraints in allocation of predetermined resources for transmission groups.
